(19) United States
(12) Patent Application Publication
(10) Pub. No.: US 2026/0268697 A1
(43) Pub. Date: Sep. 10, 2026

(54) INFORMATION PROCESSING METHOD, INFORMATION PROCESSING DEVICE, AND PROGRAM

(71) Applicant: SONY GROUP CORPORATION, TOKYO (JP)

(72) Inventors: JUN EJIRI, TOKYO (JP); TERUNARI FUJI, TOKYO (JP)

(21) Appl. No.: 19/166,091

(22) PCT Filed: Feb. 21, 2024
(86) PCT No.: PCT/JP2024/006153

§ 371 Date: Sep. 17, 2025

(30) Foreign Application Priority Data
Mar. 30, 2023 (JP) 2023-056605

(51) Int. Cl. G06V 20/64

(52) U.S. Cl. CPC G06V 20/653

(57) ABSTRACT

An information processing method of the present disclosure includes clustering processing of a point cloud, attribute determination processing, cluster complementary processing, and attribute assigning processing. In the clustering processing of a point cloud, the point cloud is classified into a plurality of clusters indicating lower-layer objects. In the attribute determination processing, the attribute of an object is determined for each cluster. In the cluster complementary processing, a cluster is complemented on the basis of the attribute assigned to the cluster. In the attribute assigning processing, the same attribute as that of the cluster is assigned to one or more points added to the cluster by complementation.

### FIELD

The present invention relates to an information processing method, an information processing device, and a program.

### BACKGROUND

It is studied to perform photorealistic 3D representation or 3D space simulation using point cloud data. A measurement means such as photogrammetry or light detection and ranging (LiDAR) is used to create point cloud data.

### CITATION LIST

### Patent Literature

Patent Literature 1: Japanese Unexamined Patent Publication No. 2003-529137

### SUMMARY

### Technical Problem

In a case where point cloud data is acquired using photogrammetry or LiDAR, a loss may occur in the generated point cloud data depending on the imaging position, the shape of an imaging target, or the like. In order to acquire point cloud data with less loss, it is conceivable to increase the number of imaging positions, the imaging frequency, and others; however, it is difficult to perform these in the real space due to physical restrictions or others.

Therefore, the present disclosure proposes an information processing method, an information processing device, and a program capable of acquiring point cloud data with less loss.

### Solution to Problem

According to the present disclosure, an information processing method executed by a computer is provided that comprises: classifying a point cloud into a plurality of clusters indicating lower-layer objects; determining an attribute of an object among the objects for each of the clusters; complementing a cluster among the clusters on a basis of an attribute assigned to the cluster; and assigning the same attribute as the attribute of the cluster to one or more points added to the cluster by the complementation. According to the present disclosure, an information processing device and a program for causing the computer to execute the information processing method are provided.

### BRIEF DESCRIPTION OF DRAWINGS

FIG. 1 is a diagram illustrating an overview of a data generation system.

FIG. 2 is a diagram illustrating an example of a data processing method.

FIG. 3 is a diagram illustrating an example in which an attribute is determined on the basis of user selection.

FIG. 4 is a concept diagram of an attribute candidate presentation UI.

FIG. 5 is a concept diagram of an attribute candidate presentation UI.

FIG. 6 is a concept diagram of an attribute candidate presentation UI.

FIG. 7 is a diagram illustrating an example of data generation processing.

FIG. 8 is a diagram illustrating another example of data generation processing.

FIG. 9 is a diagram illustrating another example of data generation processing.

FIG. 10 is a diagram illustrating an application example of point cloud data with attribute information to 3D rendering.

FIG. 11 is a diagram for explaining a point cloud data complementary processing using attribute data.

FIG. 12 is a diagram for explaining simulation of a 3D space using attribute data.

FIG. 13 is a diagram illustrating a hardware configuration example of an information processing device.

### DESCRIPTION OF EMBODIMENTS

Hereinafter, embodiments of the present disclosure will be described in detail on the basis of the drawings. In each of the following embodiments, the same parts are denoted by the same symbols, whereby redundant description will be omitted.

Note that the description will be given in the following order.
[1. Data Generation System]
[2. Data Processing Method]
[2-1. Processing Example 1: Hierarchization Processing Based on Specified Value of System]
[2-2. Processing Example 2: Hierarchization Processing Based on Value Specified by User]
[2-3. Processing Example 3: Termination of Hierarchization Processing Based on Termination Command]
[3. Application Example of Attribute Data]
[3-1. Photorealistic 3D Rendering]
[3-2. Complementary Processing of Point Cloud Data]
[3-3. Simulation of 3D Space]
[4. Hardware Configuration Example]
[5. Effects]

### 1. Data Generation System

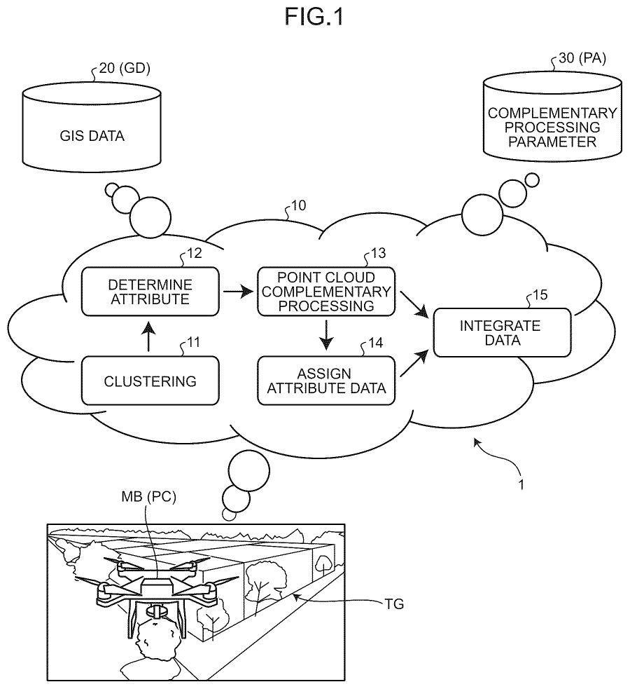

FIG. 1 is a diagram illustrating an overview of a data generation system 1.

The data generation system 1 complements a point cloud PC acquired from a robot MB to generate detailed data of the point cloud PC. The robot MB is a traveling body that can autonomously travel, such as a drone. The robot MB acquires an area for which a 3D model is to be generated as a target area TG from the data generation system 1. The robot MB generates data of the point cloud PC of the target area TG using a stereo camera, a LiDAR, or the like while traveling in the target area TG or an area around the target area TG.

For example, the data generation system 1 includes an information processing device 10, a geographic information database 20, and a parameter database 30.

The geographic information database 20 stores geographic information system (GIS) data GD. The GIS data GD includes spatial information and attribute information. The spatial information indicates the position and the shape of a feature. The attribute information indicates the attributes (type, name, material, etc.) of the feature. The spatial information and the attribute information are associated with each other by an ID assigned to each feature.

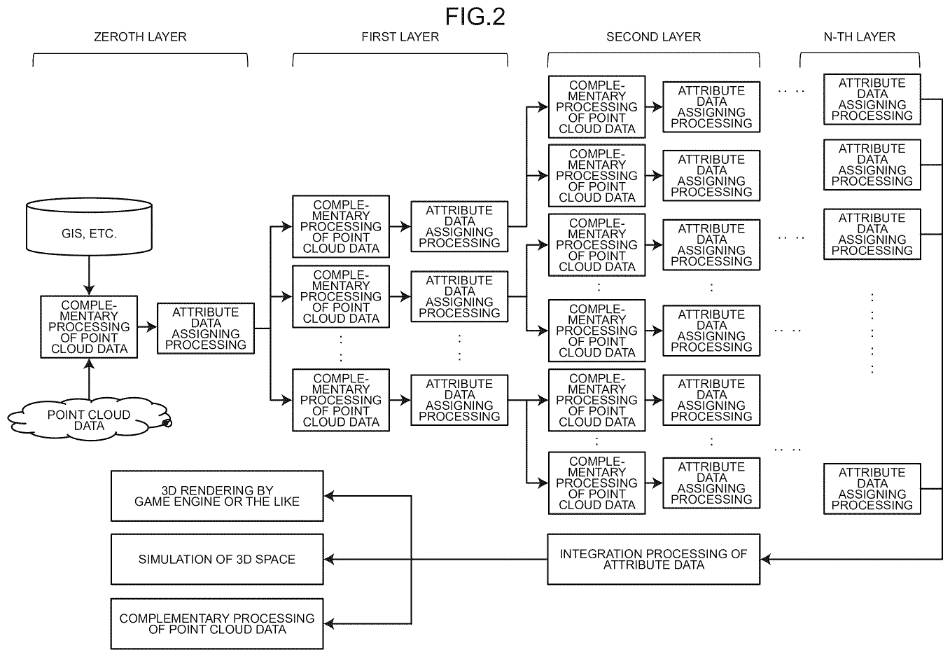

The information processing device 10 classifies the point cloud PC acquired from the robot MB into a plurality of point clouds PC (clusters) indicating lower-layer objects using attribute information of the GIS data GD. The information processing device 10 complements individual clusters obtained by the classification by using spatial information of the GIS data GD (processing in the zeroth layer: see FIG. 2).

The parameter database 30 stores various types of parameter information PA for complementing the point cloud PC. The parameter information indicates characteristics such as the shape of a feature or various objects accompanying the feature. For example, a chair is composed of parts such as a seat surface, legs, a backrest, and handrails. Characteristics such as the number and the shape of the parts are different for each chair type (dining chair, desk chair, office chair, or others). The parameter database 30 stores the characteristics such as the number and the shape of the parts for each type of chair.

The information processing device 10 classifies the individual clusters classified on the basis of the GIS data GD into a plurality of clusters indicating lower-layer objects by using a method such as semantic segmentation. The information processing device 10 complements the individual clusters obtained by the classification using the parameter information PA.

For example, the information processing device 10 includes a clustering unit 11, an attribute determination unit 12, a complementary processing unit 13, an attribute data assigning unit 14, and a data integration unit 15.

The clustering unit 11 classifies the point cloud PC into a plurality of clusters indicating lower-layer objects (clustering processing). For example, in a case where the point cloud PC indicates an urban area, the point cloud PC is classified into a plurality of point clouds PC (clusters) corresponding to stations, buildings, houses, cars, roads, street trees, and the like included in the urban area. In a case where the point cloud PC indicates a house, the point cloud PC is classified into a plurality of point clouds PC (clusters) corresponding to a roof, windows, walls, doors, and the like included in the house.

The point cloud PC can be classified on the basis of the attribute information of the GIS data GD. The point cloud PC can be classified using a known classification method such as semantic segmentation. The point cloud PC can be classified using a known classification method such as semantic segmentation while considering the attribute information of the GIS data GD.

The attribute determination unit 12 determines the attribute of an object for each cluster (attribute determination processing). An attribute means a property and a characteristic, other than the shape, of an object, such as the type, the name, the color, or a material of the object. The complementary processing unit 13 complements a cluster on the basis of attribute assigned to the cluster (complementary processing). By the complementary processing, a point or a point cloud of a portion where a defect (occlusion or the like) has occurred or a portion where the point cloud density is coarse is newly generated. The attribute data assigning unit 14 assigns the same attribute as that of the cluster to one or more points added to the cluster by the complementation (attribute assigning processing).

The data integration unit 15 integrates information of attributes of the clusters and generates attribute information of the hierarchically classified clusters (hierarchical attribute information). The data integration unit 15 integrates the data of the complemented point cloud PC with the hierarchical attribute information. As a result, the data integration unit 15 generates data of the point cloud PC in which the attribute is defined for each cluster (point cloud data with attribute information).

### 2. Data Processing Method

FIG. 2 is a diagram illustrating an example of a data processing method.

In the example of FIG. 2, the point cloud PC acquired from the robot MB is hierarchically classified from the zeroth layer to an N-th layer. For example, the clustering unit 11 classifies a point cloud PC indicating an uppermost-layer (zeroth layer) object on the basis of the GIS data GD. The clustering unit 11 classifies a point cloud PC of a cluster indicating an object in a lower layer than the uppermost layer (first to N-th layers) based on the attribute assigned to the cluster by the previous classification. The point cloud PC indicating the uppermost-layer object means the point cloud PC that is acquired from the robot MB and is before classification. The lower-layer objects mean individual objects obtained by classifying the uppermost-layer object.

For example, it is presumed that the point cloud PC acquired from the robot MB is a point cloud of a house. The clustering unit 11 recognizes that the uppermost-layer (zeroth layer) object is a house on the basis of the spatial information and the attribute information of the GIS data GD. The attribute determination unit 12 determines the attribute of the point cloud PC as “house”, The complementary processing unit 13 complements a point cloud of a portion in which a defect occurs or a portion in which the point cloud density is coarse on the basis of properties or characteristics of the “house”. The attribute data assigning unit 14 assigns the attribute of “house” to one or more points added by the complementation.

The clustering unit 11 classifies the complemented point cloud PC to which the attribute of “house” has been assigned into a plurality of clusters indicating objects in a lower layer (first layer) on the basis of the properties or characteristics of “house”. For example, a house usually includes a roof, windows, walls, and a door. The clustering unit 11 recognizes portions indicating a roof, windows, walls, and a door in the point cloud PC using a method such as semantic segmentation. The clustering unit 11 classifies the complemented point cloud PC to which the attribute of “house” has been assigned into a plurality of clusters indicating the roof, the window, the wall, and the door.

The attribute determination unit 12 determines the attribute of the point cloud PC of each of the clusters as one of “roof”, “window”, “wall”, and “door”. The complementary processing unit 13 complements a point cloud of a portion in which a defect occurs or a portion in which the point cloud density is coarse for each of the clusters on the basis of properties or characteristics of “roof”, “window”, “wall”, and “door”. The attribute data assigning unit 14 assigns, to one or more points added to the cluster by the complementation, the same attribute as that of the cluster to which the point(s) belongs/belong (“roof”, “window”, “wall”, or “door”).

Thereafter, similar processing is repeated. The clustering unit 11 classifies the complemented point cloud PC to which the attributes “roof”, “window”, “wall”, and “door” are assigned into a plurality of clusters indicating objects at a further lower layer (second layer). For example, a window typically includes a window frame, glass, a handle, and a key. The clustering unit 11 recognizes portions indicating a window frame, glass, a handle, or a key in the point cloud PC using a method such as semantic segmentation. The clustering unit 11 classifies the complemented point cloud PC to which the attribute of “window” has been assigned into a plurality of clusters indicating the window frame, the glass, the handle, and the key.

The attribute determination unit 12 determines the attribute of the point cloud PC of each of the clusters as one of “window frame”, “glass”, “handle”, and “key”. The complementary processing unit 13 complements a point cloud of a portion in which a defect occurs or a portion in which the point cloud density is coarse for each of the clusters on the basis of properties or characteristics of “window frame”, “glass”, “handle”, and “key”. The attribute data assigning unit 14 assigns, to one or more points added to the cluster by the complementation, the same attribute as that of the cluster to which the point(s) belongs/belong (“window frame”, “glass”, “handle”, or “key”). The same applies to a complemented point cloud PC to which an attribute of “roof”, “wall”, or “door” is assigned.

By similar processing, the point cloud PC acquired from the robot MB is hierarchically classified from the zeroth layer to the N-th layer. The data integration unit 15 integrates information of attributes of the clusters and generates hierarchical attribute information. The data integration unit 15 integrates the data of the complemented point cloud PC with the hierarchical attribute information to generate point cloud data with attribute information.

The point cloud data with attribute information can be used to perform photorealistic 3D representation. The point cloud data with attribute information can also be used to perform a detailed simulation of the 3D space based on the attribute information. Furthermore, the point cloud data with attribute information can also be used when the point cloud data is further complemented on the basis of the attribute information to generate high-density point cloud data.

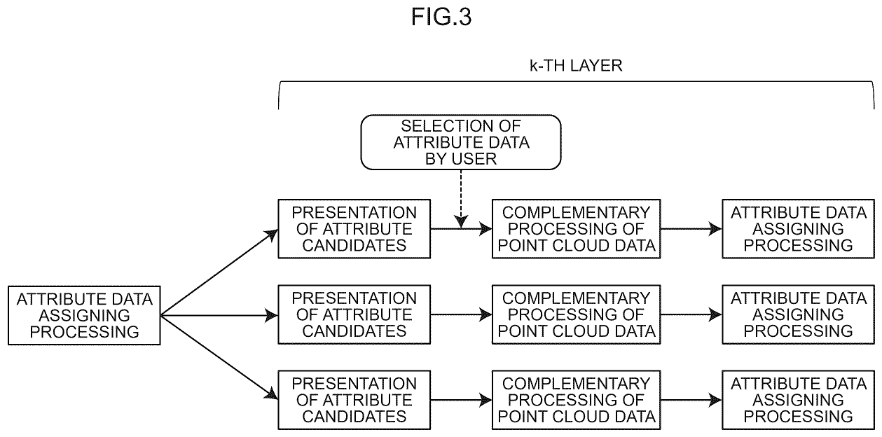

The determination of the attribute may be automatically performed by the attribute determination unit 12, or the user may manually determine the attribute, FIG. 3 is a diagram illustrating an example in which the attribute is determined on the basis of user's selection. In the example of FIG. 3, the attribute determination unit 12 generates one or more attribute candidates for each cluster. The attribute determination unit 12 determines one attribute candidate selected on the basis of user input information as the attribute of the cluster.

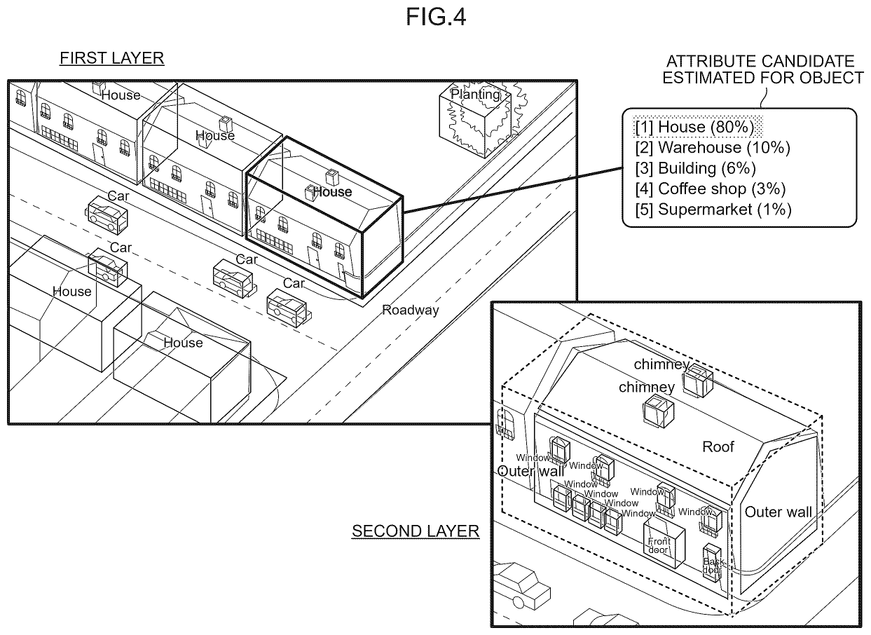

FIGS. 4 to 6 are concept diagrams of an attribute candidate presentation UI.

Data of the point cloud PC acquired from the robot MB is displayed on a UI screen. The point cloud PC is classified into a plurality of clusters based on the GIS data GD. The attribute of an object indicated by each cluster is estimated from the attribute information of the GIS data GD and others. On the UI screen, for each object, a bounding box indicating the object region and the attribute having the highest certainty factor are displayed.

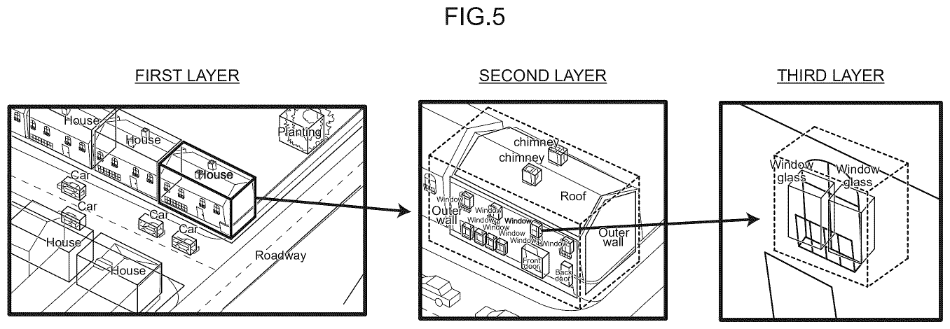

In the examples of FIGS. 4 and 5, the point cloud PC indicating an urban area is classified into a plurality of clusters. An object indicated by each cluster is added with “House”, “Roadway”, “Car”, or “Planting” as the attribute with the highest certainty factor.

The user selects a bounding box of an object to be hierarchically classified. When one bounding box is selected by the user, estimated attribute candidates are displayed in descending order of certainty factor. For example, when an object with an attribute of “House” is selected, attribute candidates of “House”, “Warehouse”, “Building”, “Coffee shop”, and “Supermarket” are displayed. The certainty factor is also described for each attribute candidate. The user can correct the attribute of an object by selecting an attribute listed as candidates.

When the user selects the bounding box, the object in the bounding box is enlarged. The enlarged object is classified into lower-layer objects. On the UI screen, for each object, a bounding box indicating the object region and the attribute having the highest certainty factor are displayed.

In the example of FIG. 4, an object having an attribute of “House” is classified into a plurality of objects having attributes of “chimney”, “Roof”, “Outer wall”, “window”, “Front door”, and “Back door”. The user can determine the attribute of lower-layer objects in the same manner as determining the attribute of “House”.

Then, repeating similar processing can hierarchically classify objects to further lower layers. In the example of FIG. 5, by selecting a bounding box with the attribute of “window”, an object in the bounding box is classified into a plurality of objects having an attribute of “window glass”.

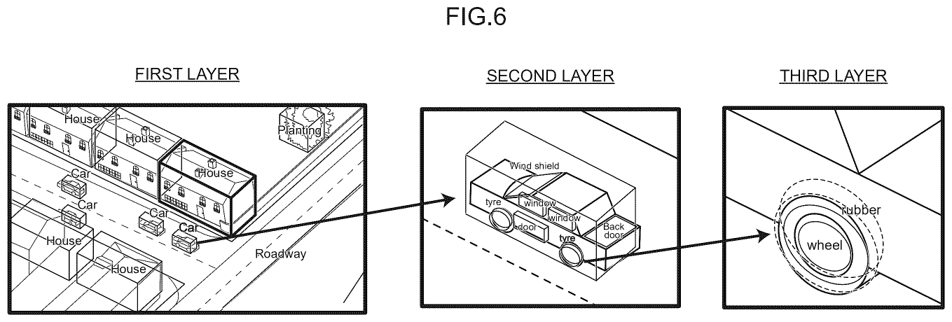

Similar processing can be performed for objects having attributes other than “House”. In the example of FIG. 6, an object having an attribute of “Car” is hierarchically classified. By selecting a bounding box with the attribute of “Car”, the object in the bounding box is classified into a plurality of objects having attributes of “Wind shield”, “window”, “tyre”, “door”, and “Back door”. By selecting a bounding box with the attribute of “tyre”, the object in the bounding box is classified into a plurality of objects having attributes of “rubber” and “wheel”.

### [2-1. Processing Example 1: Hierarchization Processing Based on Specified Value of System]

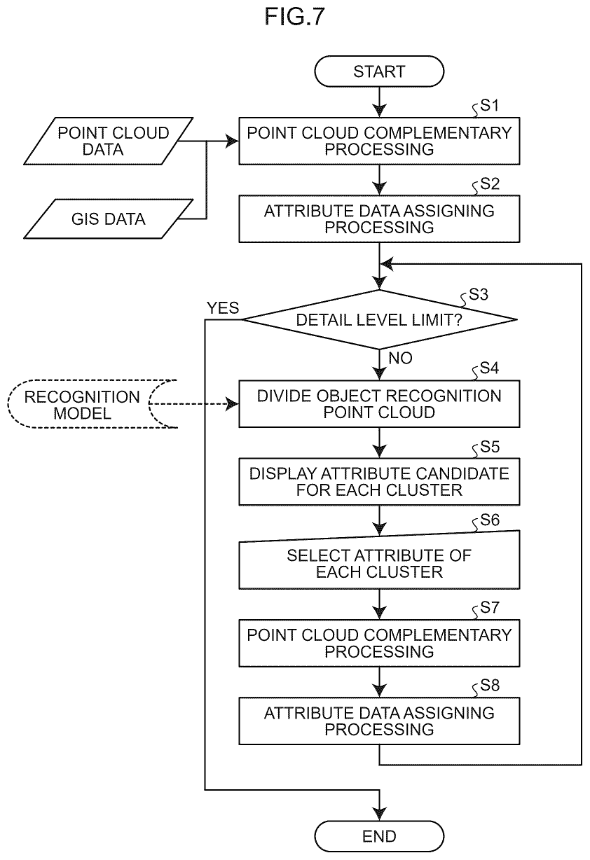

FIG. 7 is a diagram illustrating an example of data generation processing.

As described above, the clustering unit 11 hierarchically classifies clusters on the basis of the attribute information. The clustering unit 11 advances the hierarchization of clusters until the hierarchization state obtained by the classification satisfies a preset termination condition. In the example of FIG. 7, the hierarchization processing based on a specified value of the system is performed. In the system, a detail level limit indicating the number of layers serving as the limit of hierarchization is set as the specified value of the termination condition. In a case where the number of layers reaches a preset detail level limit, the clustering unit. 11 determines that the hierarchization state satisfies the termination condition.

For example, the complementary processing unit 13 complements the point cloud PC acquired from the robot MB on the basis of the GIS data GD (step S1). The attribute data assigning unit 14 assigns the attribute defined in the attribute information of the GIS data GD to the complemented point cloud PC (step S2).

The clustering unit 11 determines whether or not the number of layers has reached the detail level limit (step S3). If the number of layers has reached the detail level limit (step S3; Yes), the clustering unit 11 ends the processing. The data integration unit 15 integrates information of attributes of the clusters and generates hierarchical attribute information. The data integration unit 15 integrates the hierarchical attribute information with the data of the complemented point cloud PC to generate the point cloud data with attribute information.

If the number of layers does not reach the detail level limit (step S3: No), the clustering unit 11 classifies the point cloud PC into a plurality of clusters indicating lower-layer objects using a recognition model such as semantic segmentation (step S4). The attribute determination unit 12 displays attribute candidates of each cluster to the user using the UI (step S5). The attribute determination unit 12 determines one attribute candidate selected on the basis of user input information as the attribute of the cluster (step S6).

The complementary processing unit 13 complements the cluster on the basis of the attribute assigned to the cluster (step S7). The attribute data assigning unit 14 assigns the same attribute as that of the cluster to one or more points added to the cluster by the complementation (step S8). Then, the processing returns to step S3, and the above processing is repeated until the number of layers reaches the detail level limit,

### [2-2. Processing Example 2: Hierarchization Processing Based on Value Specified by User]

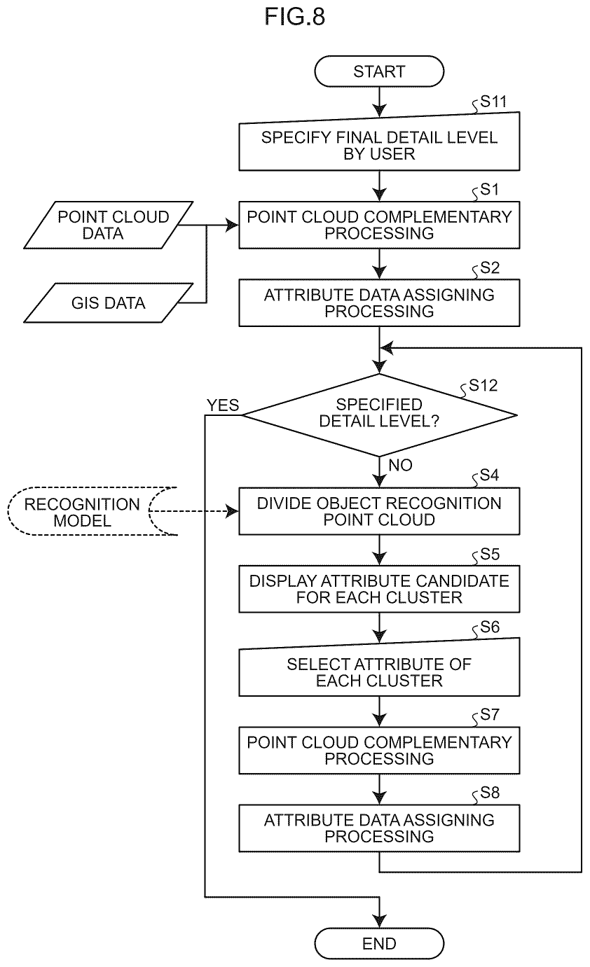

FIG. 8 is a diagram illustrating another example of the data generation processing. The example of FIG. 8 is different from the example of FIG. 7 in that a detail level limit is designated by a user. A user designates the number of layers as the final detail level before starting the data generation processing (step S11). The final detail level is registered in the system as the detail level limit. The clustering unit 11 determines the termination condition on the basis of the final detail level (step S12). The other processing is similar to that in the example of FIG. 7.

### [2-3, Processing Example 3: Termination of Hierarchization Processing Based on Termination Command]

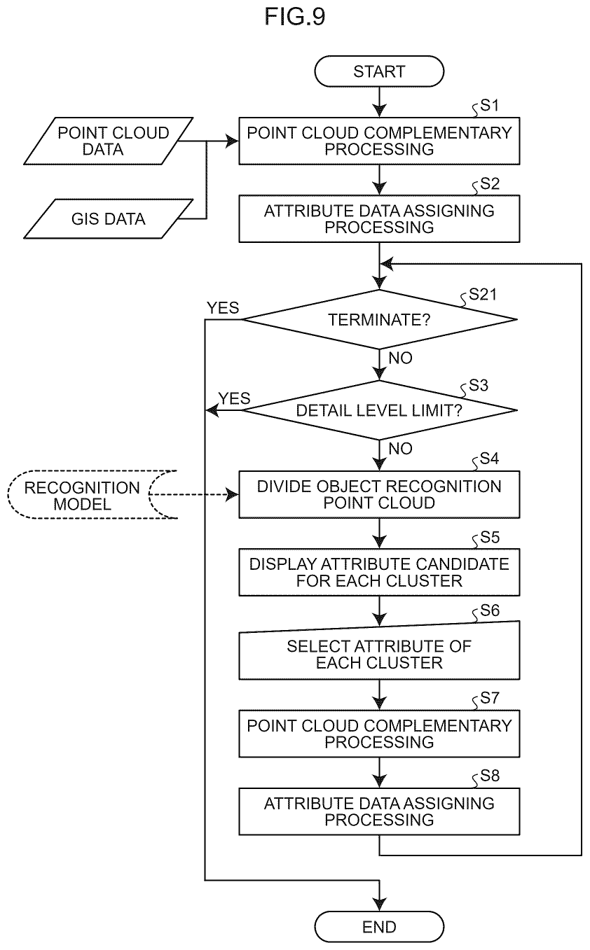

FIG. 9 is a diagram illustrating another example of the data generation processing. The example of FIG. 9 is different from the example of FIG. 7 in that the user advances the hierarchization while confirming the hierarchization state (step S21). The user determines whether or not to perform more detailed hierarchization processing by checking the results after the processing of the layers. If further hierarchization processing is unnecessary, the user can input a termination command. In a case where a termination command is received from the user, the clustering unit 11 determines that the hierarchization state satisfies the termination condition. The other processing is similar to that in the example of FIG. 7.

### 3. Application Example of Attribute Data

The point cloud data with attribute information obtained by the data generation processing includes data of an accurate shape and attribute for each part of an object. Therefore, it is expected to contribute to improvement in image quality of rendered images, improvement in the simulation accuracy of 3D spaces, and the like. Hereinafter, an application example of point cloud data with attribute information will be described.

### [3-1. Photorealistic 3D Rendering]

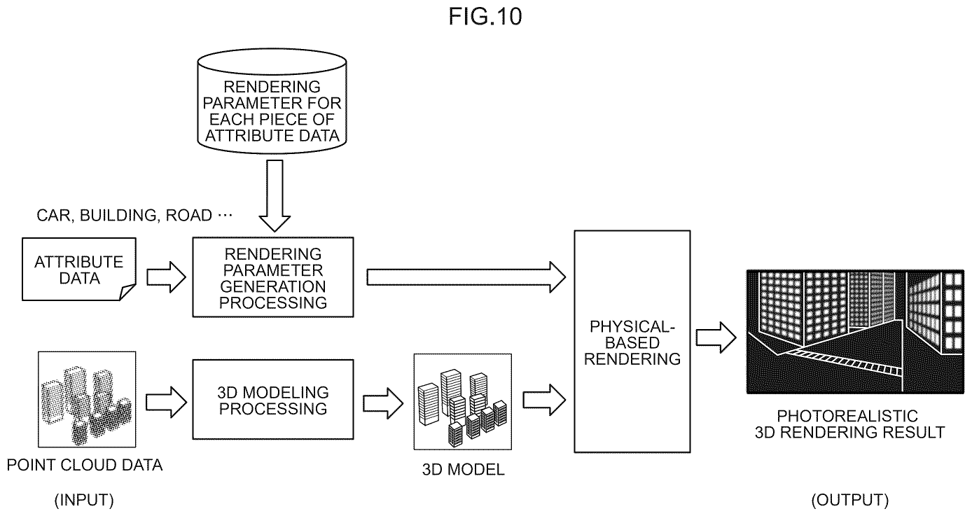

FIG. 10 is a diagram illustrating an application example of point cloud data with attribute information to 3D rendering.

The point cloud data with attribute information includes attribute data and point cloud data. The attribute data indicates attributes such as a type, a material, and a color of each part of an object. By acquiring rendering parameters for each piece of attribute data from a database and generating rendering parameters, photorealistic 3D rendering can be performed. When point cloud data is modeled in 3D, since the point cloud data in use indicates an accurate shape for each part, the obtained 3D model also has high shape reproducibility.

### [3-2, Complementing Processing of Point Cloud Data]

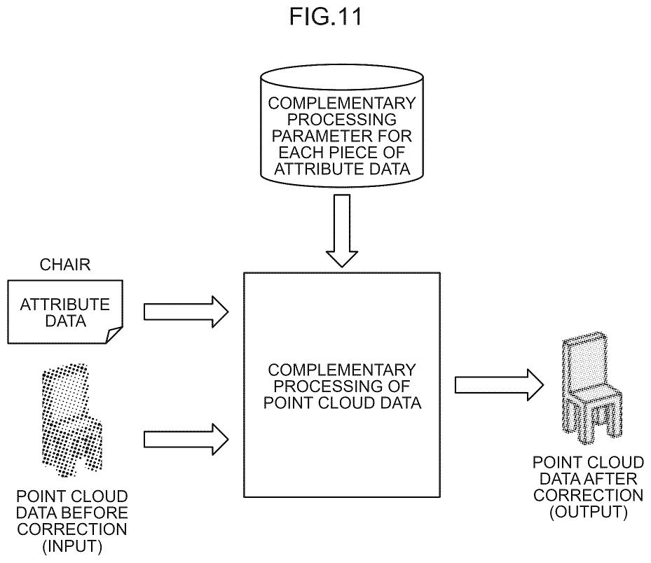

FIG. 11 is a diagram for explaining point cloud data complementary processing using attribute data.

The point cloud data with attribute information has been subjected to complementation processing of the point cloud PC in the process of hierarchization of objects. However, it is also possible to generate a high-density point cloud PC by complementing the point cloud data in more detail on the basis of the attribute data. For example, in a case where point cloud data of a chair is acquired, by specifying the type, the shape, the size, and the like of the chair on the basis of attribute data and acquiring complementary processing parameters for each piece of attribute data, more accurate point cloud data can be acquired.

### [3-3. Simulation of 3D Space]

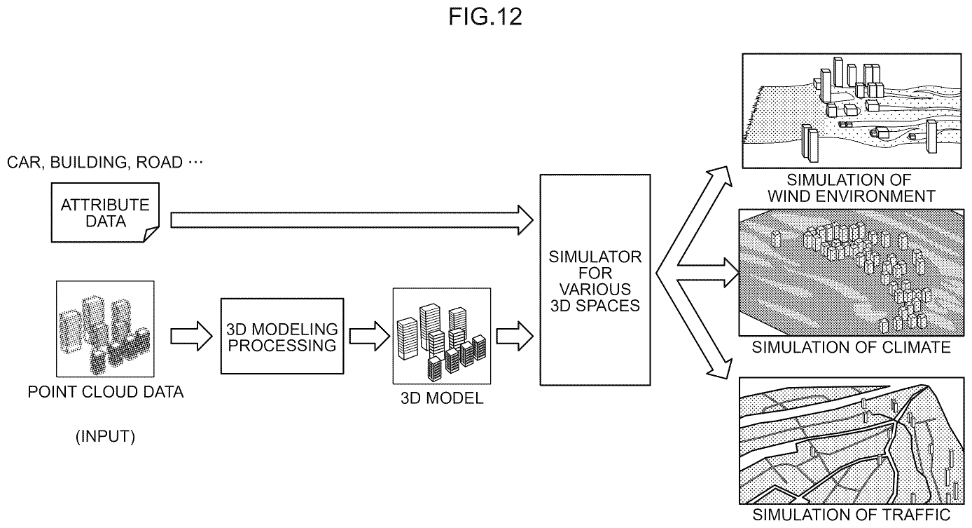

FIG. 12 is a diagram for explaining simulation of a 3D space using attribute data.

For example, in a case where simulation of a wind environment, the climate, the traffic, and the like of a city is performed, it is necessary to accurately grasp not only shapes and arrangements of buildings, houses, roads, street trees, rivers, and the like present in the city but also information of attributes such as structures, types, materials, colors, and the like thereof. In the data generation processing of the present disclosure, in the process of performing the complementary processing of the point cloud PC, an object is finely classified and hierarchized for each part, and the attribute of each part is accurately specified. Therefore, by using attribute data acquired in the process of data generation for simulation, a simulation result with high accuracy is obtained.

### 4. Hardware Configuration Example

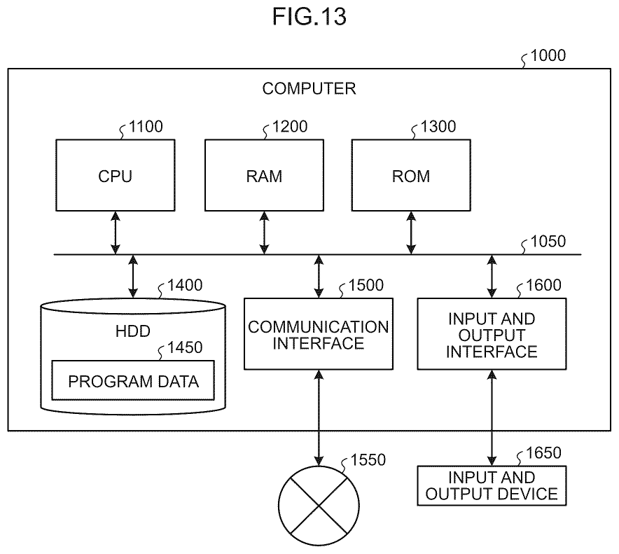

FIG. 13 is a diagram illustrating a hardware configuration example of the information processing device 10.

The information processing by the information processing device 10 is implemented by, for example, a computer 1000, The computer 1000 includes a central processing unit (CPU) 1100, a random access memory (RAM) 1200, a read only memory (ROM) 1300, a hard disk drive (HDD) 1400, a communication interface 1500, and an input and output interface 1600. The components of the computer 1000 are connected by a bus 1050.

The CPU 1100 operates in accordance with a program (program data 1450) stored in the ROM 1300 or the HDD 1400 and controls each of the units. For example, the CPU 1100 loads a program stored in the ROM 1300 or the HDD 1400 in the RAM 1200 and executes processing corresponding to various programs.

The ROM 1300 stores a boot program such as a basic input output system (BIOS) executed by the CPU 1100 when the computer 1000 is activated, a program dependent on the hardware of the computer 1000, and the like.

The HDD 1400 is a computer-readable non-transitory recording medium that non-transiently records a program to be executed by the CPU 1100, data used by such a program, and the like. Specifically, the HDD 1400 is a recording medium that records an information processing program according to the present embodiment, which is an example of the program data 1450.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 is an interface for connecting an input and output device 1650 and the computer 1000. For example, the CPU 1100 receives data from an input device such as a keyboard or a mouse via the input and output interface 1600. The CPU 1100 also transmits data to an output device such as a display device, a speaker, or a printer via the input and output interface 1600. Furthermore, the input and output interface 1600 may function as a media interface that reads a program or the like recorded in a predetermined recording medium. A medium refers to, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in a case where the computer 1000 functions as the information processing device 10 according to the embodiment, the CPU 1100 of the computer 1000 implements the functions of the units described above by executing the information processing program loaded on the RAM 1200. In addition, the HDD 1400 stores the information processing program, various models, and various types of data according to the present disclosure. Note that although the CPU 1100 reads the program data 1450 from the HDD 1400 and executes the program, as another example, these programs may be acquired from another device via the external network 1550.

### 5. Effects

The information processing method of the present disclosure includes clustering processing of a point cloud PC, attribute determination processing, cluster complementary processing, and attribute assigning processing. In the clustering processing of the point cloud PC, the point cloud PC is classified into a plurality of clusters indicating lower-layer objects. In the attribute determination processing, the attribute of an object is determined for each cluster. In the complementary processing of a cluster, the cluster is complemented on the basis of the attribute assigned to the cluster. In the attribute assigning processing, the same attribute as that of the cluster is assigned to one or more points added to the cluster by complementation. The information processing device and the program of the present disclosure cause the computer 1000 to implement the information processing method of the present disclosure.

According to this configuration, determination of the attribute and complementation of a point cloud PC are performed for each cluster obtained by clustering. The complementary processing is performed on the basis of the attribute assigned to the cluster. Therefore, missing points are appropriately Compensated, and accurate point cloud data is generated.

In the clustering processing of the point cloud PC, the point cloud PC indicating an uppermost-layer object is classified on the basis of the GIS data GD, In the clustering processing of the point cloud PC, a point cloud PC of a cluster indicating an object in a lower layer than the uppermost layer is classified on the basis of the attribute assigned to the cluster.

According to this configuration, the point cloud PC is appropriately classified.

In the clustering processing of the point cloud PC, hierarchization of the clusters is advanced until the hierarchization state obtained by the classification satisfies the preset termination condition.

According to this configuration, since the hierarchization is not performed more than necessary, the calculation load is reduced.

In the clustering processing of the point cloud PC, when the number of layers reaches a preset detail level limit, it is determined that the hierarchization state satisfies the termination condition.

According to this configuration, detailed classification is performed within a necessary range.

In the clustering processing of the point cloud PC, in a case where a termination command is received from the user, it is determined that the hierarchization state satisfies the termination condition.

According to this configuration, the user can determine termination of the hierarchization as desired.

In the attribute determination processing, one or more attribute candidates are generated for each cluster. The attribute determination processing, one attribute candidate selected on the basis of user input information is determined as the attribute of the cluster.

According to this configuration, the user can participate in the determination of the attribute.

Note that the effects described herein are merely examples and are not limited, and other effects may also be achieved,

### [Supplementary Note]

Note that the present technology can also have the following configurations.
(1)

An information processing method executed by a computer, the method comprising:
classifying a point cloud into a plurality of clusters indicating lower-layer objects;
determining an attribute of an object among the objects for each of the clusters;
complementing a cluster among the clusters on a basis of an attribute assigned to the cluster; and
assigning the same attribute as the attribute of the cluster to one or more points added to the cluster by the complementation.
(2)

The information processing method according to (1), wherein clustering processing of the point cloud includes:
classifying a point cloud indicating an uppermost-layer object on a basis of GIS data; and
classifying a point cloud of a cluster indicating an object in a lower layer than an uppermost layer on a basis of the attribute assigned to the cluster.
(3)

The information processing method according to (1) or (2), wherein
in clustering processing of the point cloud, hierarchization of the clusters is advanced until a hierarchization state obtained by classification satisfies a preset termination condition,
(4)

The information processing method according to (3), wherein
in the clustering processing of the point cloud, it is determined that the hierarchization state satisfies the termination condition in a case where the number of layers reaches a preset detail level limit,
(5)

The information processing method according to (3) or (4), wherein
in the clustering processing of the point cloud, it is determined that the hierarchization state satisfies the termination condition in a case where a termination command is received from a user.
(6)

The information processing method according to any one of (1) to (5), wherein
in determination processing of the attribute, one or more attribute candidates are generated for each of the clusters, and one attribute candidate selected on a basis of user input information is determined as an attribute of the cluster.
(7)

An information processing device comprising:
a clustering unit that classifies a point cloud into a plurality of clusters indicating lower-layer objects;
an attribute determination unit that determines an attribute of an object among the objects for each of the clusters;
a complementary processing unit that complements a cluster among the clusters on a basis of an attribute assigned to the cluster; and an attribute data assigning unit that assigns the same attribute as the attribute of the cluster to one or more points added to the cluster by the complementation.
(8)

A program for causing a computer to implement:
classifying a point cloud into a plurality of clusters indicating lower-layer objects;
determining an attribute of an object among the objects for each of the clusters;
complementing a cluster among the clusters on a basis of an attribute assigned to the cluster; and
assigning the same attribute as the attribute of the cluster to one or more points added to the cluster by the complementation.

### REFERENCE SIGNS LIST

10 INFORMATION PROCESSING DEVICE
11 CLUSTERING UNIT
12 ATTRIBUTE DETERMINATION UNIT
13 COMPLEMENTARY PROCESSING UNIT
14 ATTRIBUTE DATA ASSIGNING UNIT
GD GIS DATA
PC POINT CLOUD

1. An information processing method executed by a Computer, the method comprising:
classifying a point cloud into a plurality of clusters indicating lower-layer objects;
determining an attribute of an object among the objects for each of the clusters;
complementing a cluster among the clusters on a basis of an attribute assigned to the cluster; and
assigning the same attribute as the attribute of the cluster to one or more points added to the cluster by the complementation.

2. The information processing method according to claim 1, wherein
clustering processing of the point cloud includes:
classifying a point cloud indicating an uppermost-layer object on a basis of GIS data; and
classifying a point cloud of a cluster indicating an object in a lower layer than an uppermost layer on a basis of the attribute assigned to the cluster.

3. The information processing method according to claim 1, wherein
in clustering processing of the point cloud, hierarchization of the clusters is advanced until a hierarchization state obtained by classification satisfies a preset termination condition.

4. The information processing method according to claim 3, wherein
in the clustering processing of the point cloud, it is determined that the hierarchization state satisfies the termination condition in a case where the number of layers reaches a preset detail level limit.

5. The information processing method according to claim 3, wherein
in the clustering processing of the point cloud, it is determined that the hierarchization state satisfies the termination condition in a case where a termination command is received from a user.

6. The information processing method according to claim 1, wherein
in determination processing of the attribute, one or more attribute candidates are generated for each of the clusters, and one attribute candidate selected on a basis of user input information is determined as an attribute of the cluster.

7. An information processing device comprising:
a clustering unit that classifies a point cloud into a plurality of clusters indicating lower-layer objects;
an attribute determination unit that determines an attribute of an object among the objects for each of the clusters;
a complementary processing unit that complements a cluster among the clusters on a basis of an attribute assigned to the cluster; and
an attribute data assigning unit that assigns the same attribute as the attribute of the cluster to one or more points added to the cluster by the complementation.

8. A program for causing a computer to implement:
classifying a point cloud into a plurality of clusters indicating lower-layer objects;
determining an attribute of an object among the objects for each of the clusters;
complementing a cluster among the clusters on a basis of an attribute assigned to the cluster; and
assigning the same attribute as the attribute of the cluster to one or more points added to the cluster by the complementation.
